(19) United States
(12) Patent Application Publication
(10) Pub. No.: US 2016/0026400 A1
(43) Pub. Date: Jan. 28, 2016

(54) LOADING METHOD AND DIVIDING METHOD

(71) Applicant: APACER TECHNOLOGY INC., New Taipei City (TW)

(72) Inventors: Jiunn-Chang Lee, New Taipei City (TW); Meng-Hung Tsai, New Taipei City (TW); Yin-Chuan Liao, New Taipei City (TW)

(21) Appl. No.: 14/526,052

(22) Filed: Oct. 28, 2014

(30) Foreign Application Priority Data
Jul. 24, 2014 (TW) 103125415

(51) Int. Cl. G06F 3/06; G06F 9/44

(52) U.S. Cl. CPC G06F 3/0619; G06F 3/0644; G06F 9/441; G06F 3/0674

(57) ABSTRACT

A loading method includes steps of providing a storage device and a system, among which the storage device having at least one physical storage partition is installed in the system, booting the system, loading an identifying program, inputting an identifying information corresponding to an user, and loading the physical storage partition of the storage device corresponding to the user according to the identifying information. As a result, accesses of unauthorized users are avoided, and external accesses and software cracking are also avoided. Meanwhile, the management of the system is simplified, and a real multiboot function is achieved.

### FIELD OF THE INVENTION

The present invention relates to methods of a storage device, and more particularly to a loading method and a dividing method of a storage device.

### BACKGROUND OF THE INVENTION

With growing of the human civilization, science, technology and modernization, the development of data storage approaches mature and perfect. A variety of storage devices are developed for storing data. In recent years, solid-state disks (SSDs) play an important role in the industry.

In general, A SSD can be a 2.5 inches disk, a small module or a small chip. The usage of SSD is gradually increased for replacing the conventional hard-disk drive (HDD). The conventional SSD is usually operated with a single disk and connected through a serial advanced technology attachment (SATA) port. Since only one single disk can be connected and identified with one SATA port due to the characteristics of SATA ports, a system for multiple users configured within a SSD can be classified into two types. The first type provides a system with account managements, in which the quotas and permissions of each user are managed by an system administrator. The second type provides a system with a multiboot function, in which the single SSD is divided as at most four divisions for different users.

However, the two types mentioned above still have some drawbacks. For example, in a low level system, or A SSD is pulled out and installed as an external disk, the SSD may be simply accessed or cracked. That is, the conventional SSD is not safe enough to preventing the data from stealing Moreover, since the conventional SSD can only be divided as at most four divisions for four users, the additional SSDs have to be installed when the amount of users is larger than 4. The management of the system is limited, and the costs of the hardware are increased.

Therefore, there is a need of providing an improved loading method and an improved dividing method in order to overcome the above drawbacks.

### SUMMARY OF THE INVENTION

The present invention provides a loading method and a dividing method in order to overcome the above-mentioned drawbacks encountered by the prior arts.

The present invention provides a loading method and a dividing method. By the identifying program, accesses of unauthorized users are avoided, and external accesses and software cracking are also avoided. Meanwhile, the management of the system is simplified, and a real multiboot function is achieved.

The present invention provides a loading method and a dividing method. Since the storage device is divided to have physical storage partitions corresponding to the amount of users, multiple users may share single storage device. Furthermore, the amount of users is unlimited, the limitation of the management and the costs of the hardware of the system are reduced.

In accordance with an aspect of the present invention, there is provided a loading method. The loading method includes steps of providing a storage device and a system, among which the storage device having at least one physical storage partition is installed in the system, booting the system, loading an identifying program, inputting an identifying information corresponding to an user, and loading the physical storage partition of the storage device corresponding to the user according to the identifying information.

In accordance with another aspect of the present invention, there is provided a dividing method. The dividing method includes steps of providing a storage device, and dividing the storage device to have n physical storage partitions corresponding to n users, wherein n is a natural number.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the flow chart of a loading method of a storage device according to an embodiment of the present invention;

FIG. 2 schematically illustrates the detailed flow chart of a loading method of a storage device according to an embodiment of the present invention;

FIG. 3 schematically illustrates the corresponding relation of the disk logical block address of the storage device and the system logical block address of the system according to an embodiment of the present invention; and

FIG. 4 schematically illustrates the flow chart of a dividing method of a storage device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

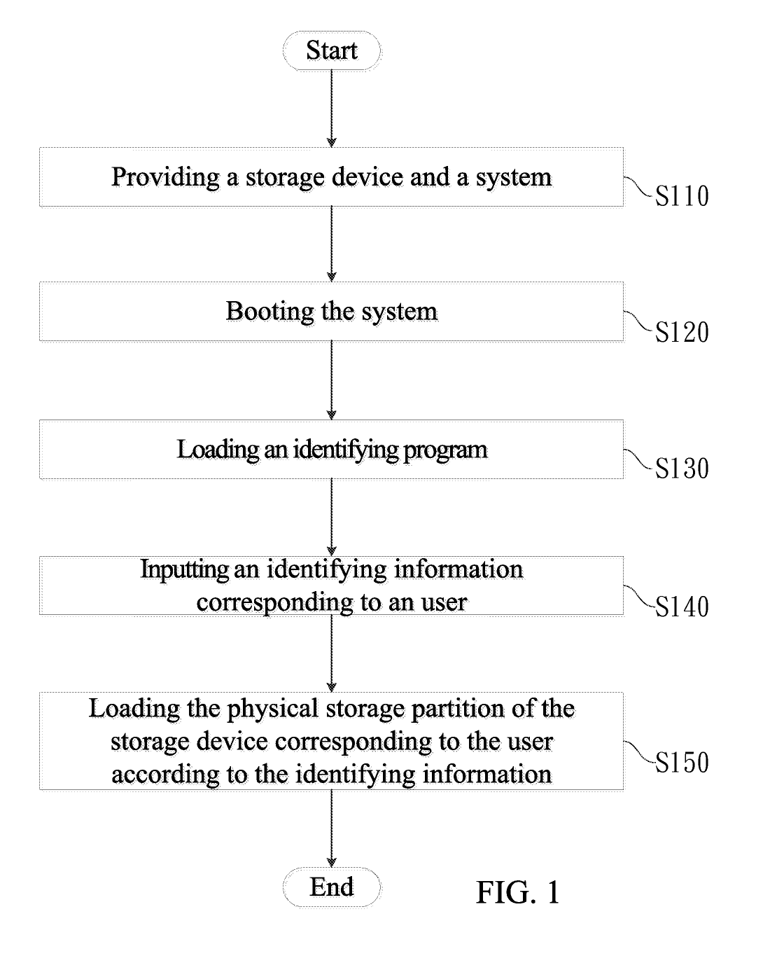

Please refer to FIG. 1. FIG. 1 schematically illustrates the flow chart of a loading method of a storage device according to an embodiment of the present invention. As shown in FIG. 1, a loading method of the present invention includes steps as follows. At first, as shown in step S110, providing a storage device and a system. The storage device is installed in the system. The storage device has at least one physical storage partition. Next, booting the system as shown in step S120, which can be for example implemented through a cold boot, but not limited herein. Then, as shown in step S130, loading an identifying program. The identifying program is built and stored in the firmware of the storage device, so that the identifying program cannot be accessed by any user. Not only the management of the developer is simplified, but also the safety is enhanced. The identifying program is not limited to an user account identifying program, a password identifying program or a biological feature identifying program. Next, as shown in step S140, inputting an identifying information corresponding to an user. The identifying information is not limited to an user account, a password or a biological feature. Then, as shown in step S150, loading the physical storage partition of the storage device corresponding to the user according to the identifying information. As a result, accesses of unauthorized users are avoided, and external accesses and software cracking are also avoided. Meanwhile, the management of the system is simplified, and a real multiboot function is achieved.

In some embodiments, if an error identifying information is inputted by the user, none of any physical storage partition is loaded by the system, hence the high-safety information security is implemented.

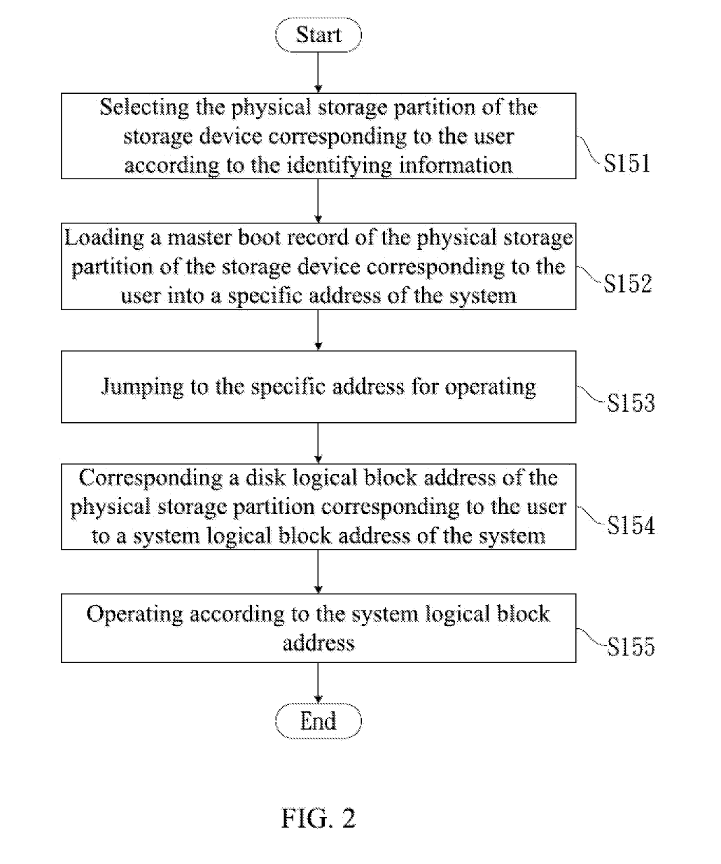

Please refer to FIG. 1 and FIG. 2. FIG. 2 schematically illustrates the detailed flow chart of a loading method of a storage device according to an embodiment of the present invention. As shown in FIG. 1 and FIG. 2, the step S150 further includes steps as follows. At first, selecting the physical storage partition of the storage device corresponding to the user according to the identifying information as shown in step S151. Next, performing steps S152 and S153 and steps S154 and S155 according to the characteristics and demands of the system for implementing the loading method of the present invention.

As shown in steps S152 and S153, since the master boot record (MBR) will be loaded by the BIOS, a master boot record (MBR) of the physical storage partition of the storage device corresponding to the user is loaded into a specific address of the system so as to be converted into a specific storage region at first. In most embodiments, the specific address is 0x0000:7C00 in hexadecimal code. That is, in most systems, the MBR is loaded into the 0x0000:7C00 address. Under this circumstance, a MBR of the physical storage partition of the storage device corresponding to the user is loaded into a specific address of the system to replace the original MBR stored in the memory of the system, such that the original MBR is replaced by the MBR corresponding to the specific storage region as shown in step S152. Then, as shown in step S153, jumping to the specific address for operating.

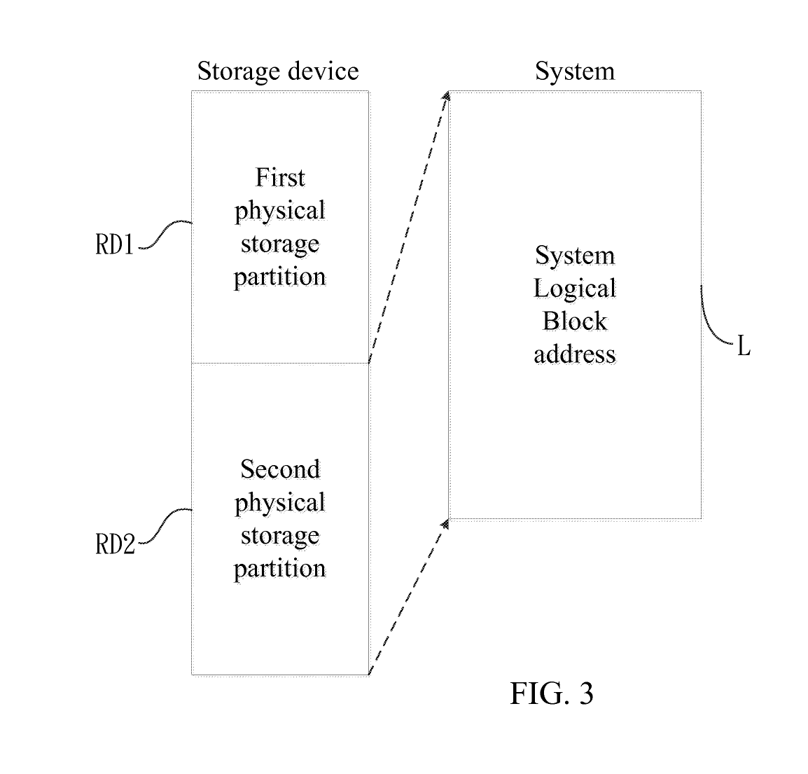

As shown in steps S153 and 153, an address mapping technology is utilized for corresponding a disk logical block address of the physical storage partition corresponding to the user to a system logical block address of the system, and the system is operated according to the system logical block address. Please refer to FIG. 3. FIG. 3 schematically illustrates the corresponding relation of the disk logical block address of the storage device and the system logical block address of the system according to an embodiment of the present invention. For example, when the physical storage partition corresponding to a first user is a first physical storage partition RD1, the disk logical block address of the first physical storage partition RD1 is from 1 to 500, and the system logical block address L is from 1 to 500, the addresses 1 to 500 of the disk logical block address are mapped to the addresses 1 to 500 of the system logical block address L. On the other hand, when the physical storage partition corresponding to a second user is a second physical storage partition RD2, and the disk logical block address of the second physical storage partition RD2 is from 501 to 1000, the addresses 501 to 1000 of the disk logical block address are mapped to the addresses 1 to 500 of the system logical block address L. Therefore, the loading method of the storage device of the present invention is implemented through the address mapping technology, and the physical storage partitions are independent. The management of the system is simplified, and a real multiboot function is achieved.

Furthermore, according to the embodiments mentioned above, it should be noted that when an user wants to execute a switch operation in manner of the loading method of the storage device of the present invention, at least one cold boot has to be executed for accomplishing the switch operation.

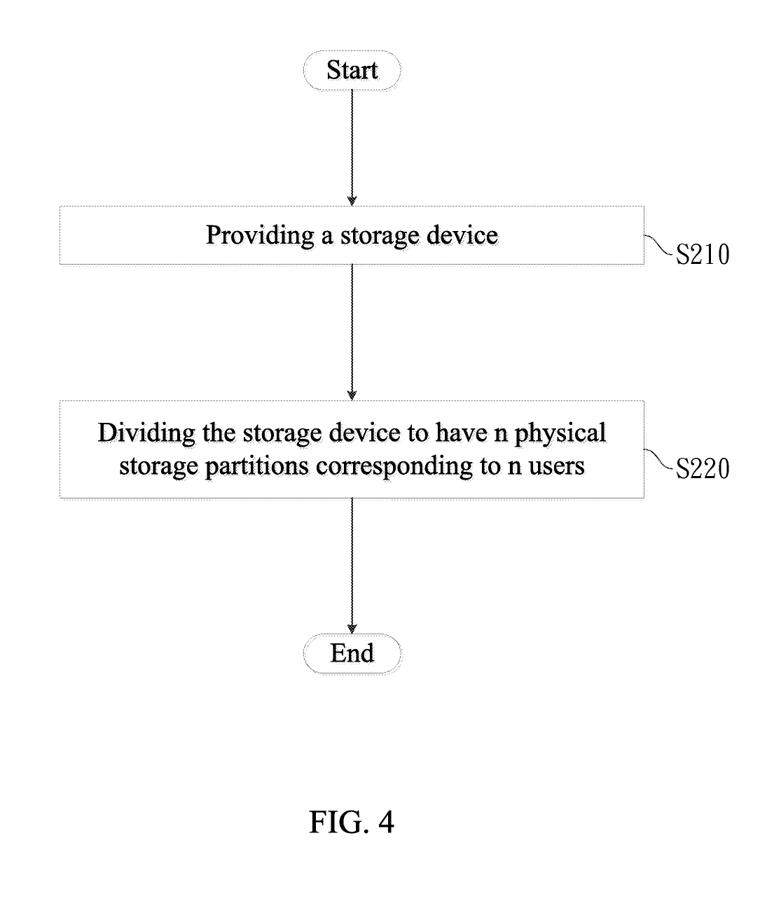

Please refer to FIG. 4. FIG. 4 schematically illustrates the flow chart of a dividing method of a storage device according to an embodiment of the present invention. As shown in FIG. 4, a dividing method of the present invention includes steps as follows. At first, providing a storage device as shown in step S210. Then, as shown in step S220, dividing the storage device to have n physical storage partitions corresponding to n users, among which n is a natural number. Via the dividing method, the amount of physical storage partitions and the amount of users are matched. Since the storage device is divided to have physical storage partitions corresponding to the amount of users, multiple users may share single storage device. Moreover, the amount of users is unlimited, the limitation of the management and the costs of the hardware of the system are reduced.

In some embodiments, the storage device divided by the above-mentioned dividing operation may be divided to have physical storage partitions in proportional ratio, unequal proportional ratio or any ratio.

From the above descriptions, the present invention provides a loading method and a dividing method. By the identifying program, accesses of unauthorized users are avoided, and external accesses and software cracking are also avoided. Meanwhile, the management of the system is simplified, and a real multiboot function is achieved. In addition, since the storage device is divided to have physical storage partitions corresponding to the amount of users, multiple users may share single storage device. Furthermore, the amount of users is unlimited, the limitation of the management and the costs of the hardware of the system are reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A loading method, comprising steps of:
(a) providing a storage device and a system, wherein the storage device has at least one physical storage partition, and the storage device is installed in the system;
(b) booting the system;
(c) loading an identifying program;
(d) inputting an identifying information corresponding to an user; and
(e) loading the physical storage partition of the storage device corresponding to the user according to the identifying information.

2. The loading method according to claim 1, wherein the step (b) is implemented through a cold boot.

3. The loading method according to claim 1, wherein the identifying program is an user account identifying program, a password identifying program or a biological feature identifying program.

4. The loading method according to claim 1, wherein the identifying information is an user account, a password or a biological feature.

5. The loading method according to claim 1, wherein the step (e) further comprises steps of:
(e1) selecting the physical storage partition of the storage device corresponding to the user according to the identifying information;
(e2) loading a master boot record of the physical storage partition of the storage device corresponding to the user into a specific address of the system; and
(e3) jumping to the specific address for operating.

6. The loading method according to claim 5, wherein the specific address is 0x0000:7C00 in hexadecimal code.

7. The loading method according to claim 5, wherein the step (e) further comprises steps of:
(e4) corresponding a disk logical block address of the physical storage partition corresponding to the user to a system logical block address of the system; and
(e5) operating according to the system logical block address.

8. A dividing method of a storage device, comprising steps of:
providing a storage device; and
dividing the storage device to have n physical storage partitions corresponding to n users, wherein n is a natural number.
